(19) United States
(12) Patent Application Publication
(10) Pub. No.: US 2026/0341573 A1
(43) Pub. Date: Oct. 29, 2026

(54) MAGNETIC CORE AND COIL DEVICE

(71) Applicant: TAMURA CORPORATION, Tokyo (JP)

(72) Inventors: Takayuki MIYASHITA, Saitama (JP); Mitsuhiro ISHIZU, Tokyo (JP)

(73) Assignee: TAMURA CORPORATION, Tokyo (JP)

(21) Appl. No.: 19/112,431

(22) PCT Filed: May 28, 2024
(86) PCT No.: PCT/JP2024/019607

§ 371 Date: Mar. 17, 2025

(30) Foreign Application Priority Data
Jun. 1, 2023 (JP) 2023-091257

(51) Int. Cl. H01F 27/22; H01F 27/24; H01F 27/28

(52) U.S. Cl. CPC H01F 27/22; H01F 27/24; H01F 27/28

(57) ABSTRACT

Provided is a coil device that has good heat dissipation properties and that makes it possible to reduce size and weight of the coil device. A magnetic core 2 according to one embodiment of the present invention includes a first core 20. The first core 20 has a first middle leg 21, an annular part surrounding the first middle leg 21, and a first yoke 23 connecting one end of the first middle leg 21 and one end of the annular part. An end face of the first middle leg 21 and an end face of the annular part are formed on the same plane. A recess having an annular shape and into which a coil can be accommodated is formed between the first middle leg 21 and the annular part.

### TECHNICAL FIELD

The present invention relates to magnetic cores and coil devices.

### BACKGROUND ART

Since large-capacity coil devices generate a comparatively large amount of heat during use, a means for efficiently discharging the heat to the outside is necessary to obtain stable characteristics. Patent Document 1 discloses an example of a coil device provided with such a means.

Patent Document 1 discloses a transformer in which a winding (hereinafter referred to as “coil”) and a magnetic core (hereinafter referred to as “core”) are accommodated in a case made of a material with high thermal conductivity such as aluminum, and the case is filled with a filler material such as silicon resin. A cooling device such as cooling fins is provided outside the case, and heat generated in the element section of the transformer (i.e., the coil and the core) is efficiently discharged to the outside through the filler material and the case.

### PRIOR ART DOCUMENT

### Patent Document

[Patent Document 1] Japanese Patent Application Publication No. 2008-153293

### SUMMARY OF THE INVENTION

### Problem to be Solved by the Invention

However, since the transformer disclosed in Patent Document 1 has a structure in which the entire element section, including the core, is accommodated in the case, it is difficult to reduce size and weight.

The present invention has been made in view of the above circumstances, and the object of the present invention is to provide a coil device that has good heat dissipation properties and that makes it possible to reduce size and weight of the coil device.

### Means for Solving the Problem

A magnetic core according to one embodiment of the invention includes a first core. The first core has a first middle leg, an annular part surrounding the first middle leg, and a first yoke connecting one end of the first middle leg and one end of the annular part. An end face of the first middle leg and an end face of the annular part are formed on the same plane. A recess having an annular shape and into which a coil can be accommodated is formed between the first middle leg and the annular part.

In the above magnetic core, the recess may be surrounded by the first middle leg, the annular part and the first yoke to allow storage of liquid filler material.

By using a magnetic core having such configuration in a coil device and filling the recess with filler material, heat generated in the coil can be quickly dissipated through the first core. Therefore, it is no longer necessary to accommodate the entire element section of the coil device, including the magnetic core, in a heat dissipation case, and thus it becomes possible to make the coil device smaller and lighter while ensuring good heat dissipation properties.

In the above magnetic core, the first core may have a pair of first side legs, and a pair of third yokes connecting the pair of first side legs and the first yoke, the pair of first side legs and the pair of third yokes being connected to form the annular part.

In the above magnetic core, the third yoke may be formed with a hole or groove, extending parallel to the first middle leg, through which a bolt for fixing is to be inserted.

According to this configuration, it becomes possible to mount the magnetic core without using mounting brackets, making it possible to reduce the size and weight of the coil device.

In the above magnetic core, the first core may be assembled from a main part and a pair of sub parts, the main part having the first middle leg, the pair of first side legs, and the first yoke, and the sub part having the third yoke.

According to this configuration, sizes of components of the magnetic core can be reduced to the same level as those of an E-shaped core of the same capacity, making it possible to form the core using the same press equipment as the E-shaped core. It is also possible to reduce sizes of molds used to form the magnetic core.

The above magnetic core may include a second core. The second core may have a second middle leg, and at least in one direction around the second middle leg, an area that is not surrounded by a portion of the second core and that is wider than the second middle leg may be formed.

According to this configuration, it becomes possible to adjust an inductance value by adjusting a length of the second middle leg by cutting machining or the like.

In the above magnetic core, the second core may have a pair of second side legs facing each other across the second middle leg, and a second yoke connecting one end of the second middle leg and one end of the pair of second side legs.

According to one embodiment of the invention, there is provided a coil device including the magnetic core of any of the above, the coil accommodated in the recess and into which the first middle leg is inserted, the filler material filled into the recess of the first core, and an attachment configured to mount the coil device on a mounting surface. A flat heat dissipation surface is formed on one face of the first core except for a face on which the recess is formed, and the attachment is configured to be capable of mounting the coil device to the mounting surface so that the heat dissipation surface is pressed against the mounting surface.

### Effect of the Invention

According to one embodiment of the present invention, there is provided a coil device that has good heat dissipation properties and that makes it possible to reduce size and weight of the coil device.

### BRIEF DESCRIPTION OF THE DRAWINGS

FIG. 1 is an external view of a switching transformer according to a first embodiment of the present invention.

FIG. 2 is an exploded view of the switching transformer according to the first embodiment of the present invention.

FIG. 3 is a plan view of a core.

FIG. 4 is a side view of a second core (lid-shaped core).

FIG. 5 is a perspective view of a first core (box-shaped core) according to a second embodiment of the present invention.

FIG. 6 is an exploded view of a core according to a third embodiment of the present invention.

### EMBODIMENTS FOR CARRYING OUT THE INVENTION

Embodiments of the present invention will be described below with reference to the drawings. In the following description, identical or corresponding items are marked with identical or corresponding reference numerals, and redundant descriptions are herein omitted.

### First Embodiment

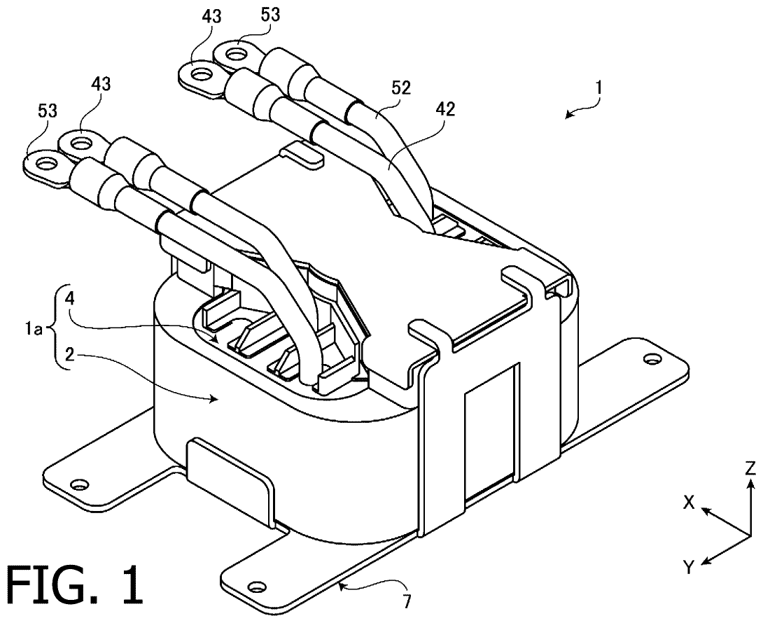

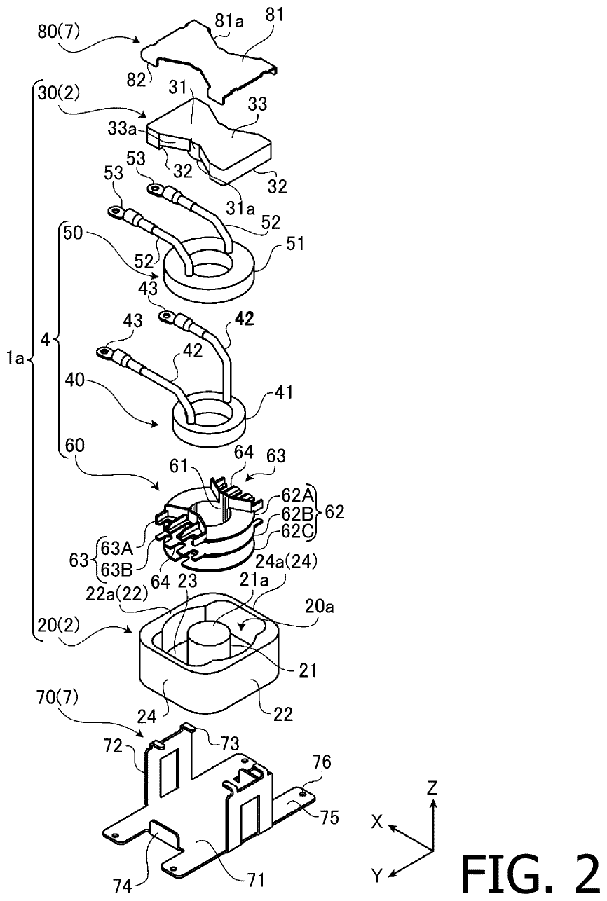

FIGS. 1 and 2 show an external view and an exploded view, respectively, of a switching transformer 1 according to a first embodiment of the present invention. The switching transformer 1 is a large-capacity coil device used, for example, in quick charging devices for electric vehicles.

In the following description, a direction from the bottom right to the top left in FIG. 1 is defined as an X direction, a direction from the top right to the bottom left in FIG. 1 is defined as a Y direction, and a direction from the bottom to the top in FIG. 1 is defined as a Z direction. The X direction, the Y direction and the Z direction are mutually orthogonal. The switching transformer 1 may be used with any of the X direction, the Y direction and the Z direction, as well as directions in-between them, oriented vertically. In the following description, for convenience of explanation, the X direction is occasionally referred to as a lengthwise direction or a front-back direction, the Y direction is occasionally referred to as a widthwise direction or a left-right direction, and the Z direction is occasionally referred to as a height wise direction or an up-down direction.

The switching transformer 1 includes a main body 1a, and a mounting bracket 7 (attachment) for mounting the main body 1a to, for example, a cooling surface of a heat sink or cooling device. The main body 1a includes a core 2 and a coil section 4.

As shown in FIG. 2, the coil section 4 includes a coil 40 on a primary side, a coil 50 on a secondary side, and a bobbin 60 around which the coils 40 and 50 are wound. The coils 40 and 50 are spirally wound conductor wires with insulating coating such as enamel. A pair of leads 42 and a pair of leads 52 are drawn from both ends of wound sections 41 and 51 of the coils 40 and 50, respectively, and crimp terminals 43 and crimp terminals 53 are attached to ends of the leads 42 and the leads 52, respectively. Allowable currents of the coils 40 and 50 and the leads 42 and 52 are 5 A or more.

The coil 40 and the coil 50 are wound around the bobbin 60 and accommodated together with the bobbin 60 in a hollow part of the core 2 (an accommodating part 20a of the core 20 which will be described later).

The bobbin 60 is made of electrically insulating materials such as phenolic resin, epoxy resin, unsaturated polyester-based resin, urethane resin, BMC (Bulk Molding Compound), PPS (Polyphenylene Sulfide), PBT (Polybutylene Terephthalate) or the like to ensure sufficient electrical insulation between the coils 40 and 50 and the core 2 and between the coil 40 and the coil 50.

The bobbin 60 has a cylindrical body 61 extending in the Z direction, a brim section 62 including three circular plate-shaped brim parts 62A, 62B, and 62C projecting perpendicularly from an outer circumference of the body 61, and a pair of lead draw-out sections 63 provided at both ends of the brim section 62 (more specifically, the brim parts 62A and 62B) in the Y direction.

The brim part 62A projects from one end portion of the body 61 in the Z direction (the top end in FIG. 2), the brim part 62B projects from a central portion of the body 61 in the Z direction, and the brim part 62C projects from the other end portion of the body 61 in the Z direction (the bottom end in FIG. 2). The coil 50 is accommodated between the brim part 62A and the brim part 62B, and the coil 40 is accommodated between the brim part 62B and the brim part 62C.

The lead draw-out section 63 includes a lead draw-out part 63A provided to the brim part 62A and a lead draw-out part 63B provided to the brim part 62B. One or more grooves 64 extending from the outside to the inside in the Y direction are formed to each of the lead draw-out parts 63A and 63B. Each of the leads 42 and 52 is drawn out through the groove 64 to the outside of the bobbin 60.

The core 2 in the present embodiment is a ferrite magnetic core and includes a core 20 (first core), which is a box-shaped magnetic core to which an accommodating part 20a being a recess in which the coil section 4 is to be accommodated is formed, and a core 30 (second core), which is the PQ-type magnetic core.

The core 20 has a cylindrical middle leg 21 (first middle leg) extending in the Z direction, a pair of side legs 22 (first side legs) facing each other in the X direction across the middle leg 21, a first yoke 23 connecting one end in the Z direction (bottom end in FIG. 2) of the middle leg 21 and one end in the Z direction (bottom end in FIG. 2) of each of the pair of side legs 22, and a pair of third yokes 24 connecting one or the other end in the Y direction of the pair of side legs 22 and the one or the other end in the Y direction of the first yoke 23. The pair of side legs 22 and the pair of third yokes 24 form an annular part surrounding the middle leg 21. The approximately E-shaped portion of the core 20 formed by the middle leg 21, the pair of side legs 22 and the first yoke 23 has the same shape as the PQ-type magnetic core (or ETD-type magnetic core). In other words, the core 20 has a shape of the PQ-type magnetic core (or ETD-type magnetic core) with openings at both ends in the Y direction closed by the pair of third yokes 24. Around the middle leg 21 is formed the accommodating part 20a, which is an annular hollow part surrounded in three directions by the pair of side legs 22, the first yoke 23, and the pair of third yokes 24 (in other words, an annular recess formed on an upper surface of the core 20). By providing the third yokes 24 and forming an annular part surrounding the coil section 4, the electromagnetic noise generated by the coils 40 and 50 is shielded by the annular part, reducing emission of electromagnetic noise to the outside.

The core 30 has a middle leg 31 (second middle leg), a pair of side legs 32 facing each other in the X direction across the middle leg 31, and a yoke 33 (second yoke) connecting one end in the Z direction (top end in FIG. 2) of the middle leg 31 and one end in the Z direction (top end in FIG. 2) of each of the pair of side legs 32. The middle leg 31 has the same cross-sectional shape as the middle leg 21 of the core 20, and the side legs 32 have the same cross-sectional shapes as the side legs 22 of the core 20. V-shaped notches 33a are formed at both ends of the yoke 33 in the Y direction.

The core 20 and the core 30 form the core 2 by making end faces of the middle leg 21 and the middle leg 31 butt each other and making end faces of the pair of side legs 22 and the pair of side legs 32 butt each other.

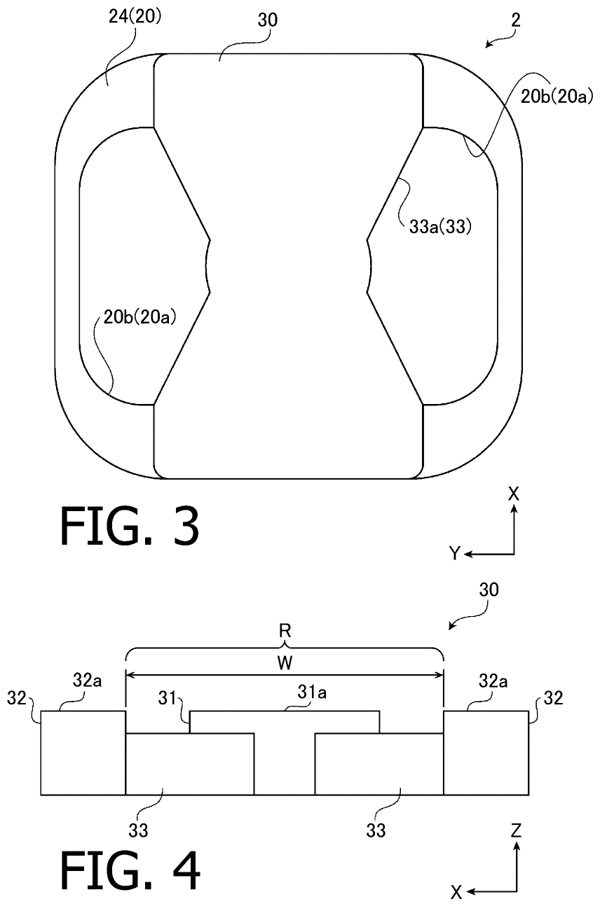

FIG. 3 is a plan view of the core 2. In the present embodiment, a length (a size in the X direction) of the core 30 is the same as a length of the core 20. A width (a size in the Y direction) of the core 30 is the same as a width of the side legs 22 of the core 20 (i.e., narrower than a width of the accommodating part 20a). Therefore, in the core 2 formed by combining the core 20 and the core 30, the accommodating part 20a is not completely blocked by the core 30, and portions of the accommodating part 20a (exposed parts 20b shown in FIG. 3) are exposed.

The coil section 4 is accommodated in the accommodating part 20a. When the core 2 is assembled with the coil section 4 accommodated in the accommodating part 20a, the lead draw-out parts 63A are positioned adjacent to both sides of the core 30 in the Y direction so as to block the exposed parts 20b. The leads 42 and 52 are then drawn out of the core 2 through these exposed parts 20b (more specifically, the grooves 64 of the lead draw-out sections 63).

The accommodating part 20a of the core 20 is filled with a thermally conductive filler material after the coil section 4 is accommodated. In the present embodiment, for example, silicon resin having a thermal conductivity of 1 W/m·K or higher (more preferably 2 W/m·K or higher) is used as the filler material. This allows heat generated by the coils 40 and 50 to be quickly transferred to the core 20 and dissipated through the mounting bracket 7 to a heat sink or a cooling device.

Since the core 20 of the present embodiment is container-shaped with the accommodating part 20a, it also functions as a case for storing filler material. Therefore, there is no need to separately provide a large case that accommodates the entire main body 1a (the core 2 and the coil section 4) of the switching transformer 1. Therefore, the number of parts and assembly man-hours can be reduced, and the size and weight of the switching transformer 1 can be made smaller and lighter.

The mounting bracket 7 is a sheet metal part formed by press working or other means from a metal sheet having high thermal conductivity, such as a copper alloy (e.g., brass), and is composed of two parts, namely a main bracket 70 and a holding bracket 80.

The main bracket 70 has a bottom plate 71, a pair of first side plates 72 extending vertically upward from both ends of the bottom plate 71 in the X direction, a pair of second side plates 74 extending vertically upward from both edges of the bottom plate 71 in the Y direction, and two pairs of claws 73 projecting inward in the X direction from the tips of the first side plates 72. Legs 75 extending in the Y direction are formed at four corners of the bottom plate 71, and through holes 76 are formed to the legs 75.

The pair of first side plates 72 are formed to be spaced apart at approximately the same distance as a length (a size in the X direction) of the core 2, and are formed parallel to each other. The pair of second side plates 74 are formed to be spaced apart at approximately the same distance as a width (a size in the Y direction) of the core 20, and are formed parallel to each other. Heights of the first side plates 72 (i.e., distances between the bottom plates 71 and the claws 73) are formed to have approximately the same distance as a height of the core 2.

The holding bracket 80 has a top plate 81, and two pairs of side plates 82 extending vertically downward from four corners of the top plate 81. Each pair of side plates 82 facing each other in the Y direction are formed to be spaced apart at approximately the same distance as a width (a size in the Y direction) of the core 30. The top plate 81 is formed with approximately V-shaped notches 81a at central portions of both sides in the Y direction and is formed in approximately the same shape as a top surface of the core 30.

The mounting bracket 7 is attached to the main body 1a of the switching transformer 1 by inserting the main body 1a of the switching transformer 1 between the pair of first side plates 72 and the pair of second side plates 74 of the main bracket 70, placing the main body 1a on the bottom plate 71, placing the holding bracket 80 on the main body 1a of the switching transformer 1 (at this time, the core 30 is held between the two pairs of side plates 82), and bending the two pairs of claws 73 inward.

The switching transformer 1 is attached to a heat sink or a cooling device by bolts that are inserted in the through holes 76 of the main bracket 70. At this time, the bottom plate 71 of the main bracket 70 contacts a cooling surface of the heat sink or the cooling device, and heat generated in the main body 1a of the switching transformer 1 is transferred to the cooling surface via the bottom plate 71.

Hereinafter, a procedure for assembling the switching transformer 1 will be described. First, the coil section 4 is assembled. First, the coils 40 and 50 are wound around the bobbin 60, and the leads 42 and 52 are passed through the grooves 64 of the lead draw-out sections 63 and drawn out upward (opposite to the body 61). In order to ensure insulation between the leads 42 and 52, it is preferable to limit the number of leads 42 and 52 to be passed through each groove 64 to only one. In order to ensure insulation between the leads 42 and 52, it is preferable to pass one of the pair of leads 42 or 52 of each of the coils 40 and 50 through the groove 64 of one of the pair of lead draw-out sections 63, and pass the other of the pair of leads 42 or 52 of each of the coils 40 and 50 through the groove 64 of the other of the pair of lead draw-out sections 63.

Then, the coil section 4 is accommodated in the accommodating part 20a of the core 20, the filler material is poured into a gap in the accommodating part 20a, and the filler material is hardened (or de-fluidized).

Then, the core 20 is assembled with the core 30, whereby the assembly of the main body 1a is completed. At this time, the pair of lead draw-out parts 63A of the bobbin 60 are fitted into the pair of notches 33A of the core 30. In other words, the core 30 is fitted between the pair of lead draw-out parts 63A. Also, at this time, end faces 22a of the pair of side legs 22 of the core 20 and end faces 32a of the pair of side legs 32 of the core 30 butt each other. The end faces 22a of the side legs 22 and the end faces 32a of the side legs 32 may be glued together.

Finally, the mounting bracket 7 is attached to the main body 1a. In this process, first, the main body 1a (specifically, the core 20) is inserted between the pair of first side plates 72 and the pair of second side plates 74 of the main bracket 70, and the main body 1a is placed on the bottom plate 71 of the main bracket 70. Then, as the claws 73 are bent inward with a bottom surface of the core 20 appressed against the bottom plate 71, the core 2 is tightened between the bottom plate 71 and the four claws 73, whereby the mounting bracket 7 is fixed to the main body 1a and the assembly of the switching transformer 1 completes.

A magnetic gap is formed between an end face 21a of the middle leg 21 of the core 20 and an end face 31a of the middle leg 31 of the core 30. In order to provide the core 2 with a predetermined inductance value, a gap length of the magnetic gap needs to be precisely adjusted by, for instance, grinding the end face 21a of the middle leg 21 or the end face 31a of the middle leg 31.

As described above, the accommodating part 20a of the core 20 is filled with the filler material. To improve heat dissipation properties of the main body 1a, it is preferable to fill the accommodating part 20a with the filler material up to near an upper limit of the accommodating part 20a so as to make a surface area of the core 20 exposed to the air as small as possible. If the filler material adheres to the end faces of the core 20 (the end faces 21a, 22a, and end faces 24a of the third yokes 24), it becomes difficult to adjust the magnetic gap and the thermal expansion of the filler material may cause the magnetic gap to fluctuate, resulting in unstable inductance values. Therefore, in the core 20 of the present embodiment, the end faces 21a, 22a, and 24a of the core 20 are formed on the same plane perpendicular to the Z direction. Therefore, it is not desirable to vary the length of the middle leg 21 of the core 20.

Furthermore, since the middle leg 21 is surrounded by the pair of annularly connected side legs 22 and the first yoke 23, it is difficult to perform cutting or grinding on only the end face 21a of the middle leg 21.

FIG. 4 is a side view of the core 30 viewed in the Y direction. In FIG. 4, only the middle leg 31 and the yoke 33 are present in a region R sandwiched between the pair of side legs 32. A width W of the region R is large enough to insert tools such as an end mill used for machining the end face 31a. Since the tip of the middle leg 31 projects from the yoke 33, the yoke 33 does not interfere with the machining of the end face 31a of the middle leg 31. In other words, since there is no structure within the region R that interferes with the machining of the end face 31a, it is possible to perform cutting and grinding on the end face 31a by introducing tools into the region R from the Y direction. In other words, by using the PQ-type magnetic core for the core 30, with the core 2 of the present embodiment, it is made possible to adjust the inductance value by cutting or grinding the end face 31a of the middle leg 31 of the core 30.

In addition to the PQ-type, the shape of the core 30 is preferably, for example, the E-type, ETD-type, ER-type, EL-type, EFD-type, EP-type, RM-type, or the pot-type, with at least one gap of a width (at least wider than the middle leg 31) through which a tool can be inserted to between the side legs. In other words, it is preferable that the core 30 has a shape in which, in at least one direction around the middle leg 31, a region wider than the middle leg 31 (i.e., a region of a width through which the tools can be inserted) that is not surrounded by a portion of the core 30 is formed. Using the core 30 of such a shape facilitates adjustment of the inductance value by the adjustment of the length of the middle leg 31 by cutting or grinding. The core 30 may be of a shape that does not have the middle leg 31 and/or the side legs 32, such as, for instance, a simple flat plate or a block shape.

### Second Embodiment

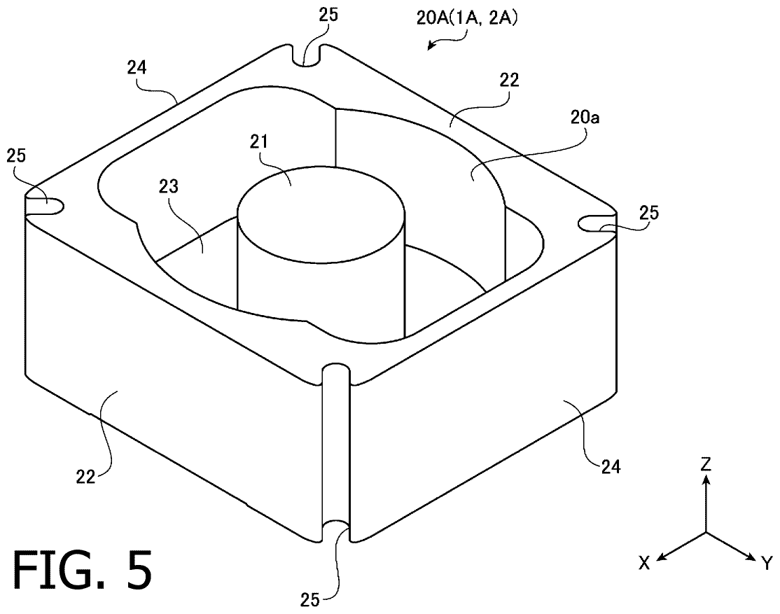

FIG. 5 is a perspective view of a core 20A of a switching transformer 1A according to a second embodiment of the present invention. The switching transformer 1A of the second embodiment differs from the switching transformer 1 of the first embodiment only in the shape of a core 20A (core 2A).

At four corners of the core 20A, grooves 25 (attachment) of which cross sections are U-shaped and that penetrate in the Z direction (i.e., extending parallel to the middle leg 21) are formed. The core 20A differs from the core 20 of the first embodiment only in that the grooves 25 are formed. Bolts are to be inserted into the grooves 25. These bolts allow the core 20A (switching transformer 1A) to be attached, for example, to the cooling surface of a heat sink or a cooling device. Therefore, the switching transformer 1A of the present embodiment can be attached to a heat sink or the like without using the mounting bracket 7 of the first embodiment, whereby enabling reduction in size and weight of the switching transformer 1A. Since the core 30 is not placed on the third yokes 24 to which the grooves 25 are formed (see FIG. 3), the bolts that are inserted into the grooves 25 do not interfere with the core 30. In addition, since a height of a head of a bolt is generally smaller than a thickness of the core 30, a height of the switching transformer 1A will not be increased by the insertion of the bolts into the grooves 25.

In place of the grooves 25, through holes into which the bolts are to be inserted may be provided to the core 20A. A reinforcing collar (cylindrical metal member) may be inserted into an inner circumference of the groove 25 or the through hole, and the bolt may be inserted into a hollow space of the collar. If the core 20A is a ferrite magnetic core, the collar is not necessary because the ferrite magnetic core has high compressive strength, but if the core 20A is a powder magnetic core, the reinforcement with a collar is necessary.

### Third Embodiment

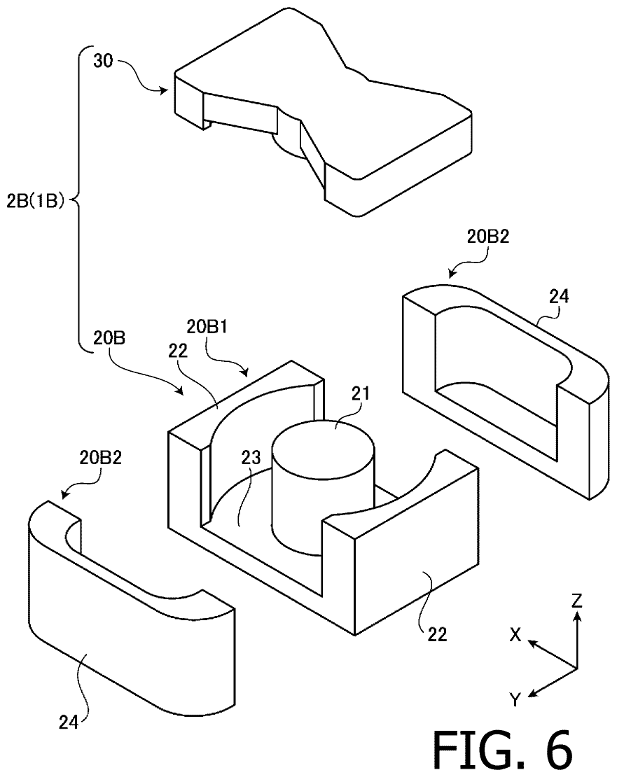

FIG. 6 is an exploded view of a core 2B of a switching transformer 1B according to a third embodiment of the present invention. The switching transformer 1B of the third embodiment differs from the switching transformer 1 of the first embodiment only in the shape of a core 2B (more specifically, a core 20B).

The core 20B of the present embodiment is formed by cutting the core 20 of the first embodiment along planes perpendicular to the Y direction to divide into three parts (main part 20B1 and a pair of sub parts 20B2). The main part 20B1 is an ETD-type magnetic core and has the middle leg 21, the pair of side legs 22 facing each other in the X direction across the middle leg 21, and the first yoke 23 connecting the bottom end of the middle leg 21 and the bottom ends of the pair of side legs 22. The sub part 20B2 consists of the third yoke 24. In other words, the core 20B of the present embodiment can be said to be the one in which the two third yokes 24 are separated from the core 20 of the first embodiment.

The main part 20B1 and the two sub parts 20B2 are assembled and bonded together, for example, with epoxy adhesive to form the core 20B. An adhesive layer formed between the main part 20B1 and the two sub parts 20B2 relieves stress acting to the core 20B due to thermal expansion of the filler material, making the core 20B less susceptible to cracking. Another type of adhesive may be used for bonding. Various types of welding, brazing, bolt joining, or other alternative methods may be used to bond the members that make up the core 20B.

Ferrite cores are manufactured by forming (press forming) and then sintering powder material. The box-shaped core 20 of the first embodiment has a larger cross-sectional area than standard E-type and ETD-type magnetic cores, thereby requiring a larger press load and a larger press forming machine for the molding of the core 20. A size of a mold required for the molding of the core 20 is also larger and thus more expensive.

The core 20B of the present embodiment is formed by assembling the main part 20B1, which is a standard ETD-type magnetic core, and two sub parts 20B2, which are of sizes similar to or smaller than the main part 20B1. Therefore, each member of the core 20B can be molded using a press forming machine used for molding standard ETD-type magnetic cores. Furthermore, since the core 20B can be molded using a smaller mold than the core 20 of the first embodiment, it is possible to reduce production cost and shorten the production period of the mold.

The main part 20B1 and the two sub parts 20B2 of the present embodiment are made of the same material, but they may be made of different materials. The material of the sub parts 20B2 may be a non-magnetic material such as resin. If the main part 20B1 and the two sub parts 20B2 are made of different materials (especially if a non-magnetic material is used for the sub parts 20B2), magnetic flux leakage will increase. It is preferable that the main part 20B1 and the two sub parts 20B2 are made of the same material or of materials with as close a magnetic permeability as possible.

The grooves 25 of the second embodiment may be provided to the sub parts 20B2.

The above-mentioned PQ-type magnetic core, E-type magnetic core, ETD-type magnetic core, ER-type magnetic core, EL-type magnetic core, EFD-type magnetic core, EP-type magnetic core, RM-type magnetic core, and pot-type magnetic core are the shapes of magnetic cores described in the Japanese Industrial Standard JIS C 2560-1: 2014.

The foregoing is the description of the embodiments of the present invention. However, the present invention is not limited to the configurations of the above-described embodiments, but various modifications are possible within the scope of its technical concept. For example, appropriate combinations of at least some of the technical configurations of one or more embodiments described in the specification with well-known technical configurations are also included in the embodiments of the present invention.

The cores 2, 2A, and 2B in each of the above-described embodiments are ferrite magnetic cores, but magnetic cores of other materials (e.g., laminated magnetic cores, powder magnetic cores, amorphous metal magnetic cores, or metal composite magnetic cores formed from resin containing magnetic particles) may be used.

In each of the above-described embodiments, a flat heat dissipating surface is formed on the bottom surface of the first core (the cores 20, 20A and 20B) of which a recess (the accommodating part 20a) is filled with the filler material, and the coil device (the switching transformers 1, 1A and 1B) is mounted to a mounting surface (e.g., the cooling surface of the heat sink or the cooling device) with the attachment so that the heat dissipating surface is pressed directly or indirectly against the mounting surface. This allows heat generated in the main body 1a to be dissipated efficiently. The heat dissipation surface is not limited to the bottom surface of the first core, but can also be provided on one of other surfaces of the first core (except for the surface where the recess is formed).

In each of the above-described embodiments, silicone resin is used as the filler material, but another type of filler material such as epoxy resin or urethane resin may be used.

In the first embodiment described above, the material of the mounting bracket 7 is brass, but another material (e.g., copper, aluminum, aluminum alloy, carbon steel, stainless steel or the like) may be used.

In the first embodiment described above, the mounting bracket 7 is a sheet metal part, but it may be machined by another process such as casting or cutting.

In each of the above-described embodiments, the middle leg is cylindrical, but it may be prismatic, elliptical, or other shape.

In each of the above-described embodiments, the magnetic gap formed between the middle leg 21 of the core 20 and the middle leg 31 of the core 30 is an air gap, but a gap member formed from non-magnetic material may be inserted between the middle leg 21 and the middle leg 31.

Although the above embodiments are applications of the present invention to a transformer, the present invention is not limited to these configuration and can be applied to various types of inductors such as, for instance, reactors and choke coils.

### DESCRIPTION OF REFERENCE NUMERALS

1, 1A, 1B switching transformer
2, 2A, 2B core
20 core
21 middle leg
22 side leg
30 core
31 middle leg
32 side leg
4 coil part
40 coil
50 coil
60 bobbin
7 mounting bracket
70 main bracket
80 pressing bracket

1. A magnetic core comprising a first core, the first core having:
a first middle leg;
an annular part surrounding the first middle leg; and
a first yoke connecting one end of the first middle leg and one end of the annular part,
wherein:
an end face of the first middle leg and an end face of the annular part are formed on the same plane, and
a recess having an annular shape and into which a coil can be accommodated is formed between the first middle leg and the annular part.

2. The magnetic core according to claim 1, wherein the recess is surrounded by the first middle leg, the annular part and the first yoke to allow storage of liquid filler material.

3. The magnetic core according to claim 1, wherein:
the first core has:
a pair of first side legs; and
a pair of third yokes connecting the pair of first side legs and the first yoke, and
the pair of first side legs and the pair of third yokes are connected to form the annular part.

4. The magnetic core according to claim 3, wherein the third yoke is formed with a hole or groove, extending parallel to the first middle leg, through which a bolt for fixing is to be inserted.

5. The magnetic core according to claim 3, wherein:
the first core is assembled from a main part and a pair of sub parts,
the main part has:
the first middle leg;
the pair of first side legs; and
the first yoke, and
the sub part has the third yoke.

6. The magnetic core according to claim 1, further comprising a second core, wherein
wherein the second core has a second middle leg, and
at least in one direction around the second middle leg, an area that is not surrounded by a portion of the second core and that is wider than the second middle leg is formed.

7. The magnetic core according to claim 6, wherein the second core has
a pair of second side legs facing each other across the second middle leg: and
a second yoke connecting one end of the second middle leg and one end of the pair of second side legs.

8. A coil device, comprising:
the magnetic core according to claim 1;
the coil accommodated in the recess and into which the first middle leg is inserted;
a filler material filled into the recess of the first core; and
an attachment configured to mount the coil device on a mounting surface,
wherein:
a flat heat dissipation surface is formed on one face of the first core except for a face on which the recess is formed, and
the attachment is configured to be capable of mounting the coil device to the mounting surface so that the heat dissipation surface is pressed against the mounting surface.
